(19) United States
(12) Patent Application Publication
(10) Pub. No.: US 2010/0051164 A1
(43) Pub. Date: Mar. 4, 2010

(54) MODULAR PLY TIRE WITH DISSIMILAR MATERIALS

(76) Inventors: Robert Anthony Neubauer, Medina, OH (US); Keith Carl Trares, Akron, OH (US); Joseph Kevin Hubbell, Akron, OH (US); Ping Zhang, Hudson, OH (US)

Correspondence Address: Emerson, Thomson & Bennett, LLC, 777 W. Market Street, Akron, OH, 44303, US

(21) Appl. No.: 12/201,090

(22) Filed: Aug. 29, 2008

(51) Int. Cl. B60C 9/02

(52) U.S. Cl. 152/564; 152/548

(57) ABSTRACT

A tire carcass is disclosed herein which includes a first radial ply, first and second sidewalls, a carcass crown portion, the carcass crown portion having a first edge and a second edge, and a non-continuous second radial ply, the second radial ply having a right side extending from approximately the first edge of the carcass crown portion, and extending approximately to at least the first bead core and a left side extending from approximately the second edge of the carcass crown portion, and extending approximately to at least the second bead core, wherein at least one of the sidewalls and the carcass crown portion are made of dissimilar material.

### I. BACKGROUND OF THE INVENTION

A. Field of Invention

This invention pertains to the art of methods and apparatuses regarding tires, and more particularly to methods and apparatuses regarding monoply tires, and even more particularly to methods and apparatuses regarding modular monoply tires, and even more particularly to the crown portion and the sidewalls being made of a dissimilar material.

B. Description of the Related Art

It is known in the art to provide monoply and two-ply tires for vehicles.

U.S. Pat. No. 7,017,635 discloses a pneumatic tire for trucks having reduced weight and less material usage. The present invention utilizes an outside-in radial ply construction, which aids to torque the tire bead into the rim of the wheel to which it is mounted and allows the rim to provide greater support for the tire. The size of the bead may be reduced, permitting a reduction in the amount of rubber and reinforcement around and above the bead.

U.S. Pat. No. 6,913,052 discloses a tire construction and a method of building a tire which comprises the steps of cylindrically applying a pair of radial cord reinforced sidewall plies, fixing the axial spacing between the bead cores; applying a crown ply, turning up each sidewall ply to overlap lateral edges of the crown ply; moving the carcass assembly axially inwardly while shaping the carcass assembly toroidially to form ply turnups axially inwardly of the bead cores.

U.S. Pat. No. 6,536,495 discloses a two-ply radial runflat tire having a belt structure, a ply structure, two inextensible beads and two wedge-insert reinforced sidewalls. The outer ply is reinforced by high-modulus, light-weight aramid. The aramid reinforcement material of the outer ply is clamped around the beads. The outer ply is prestressed in tension during manufacture of the tire. The resultant tire is light in weight and resists upward buckling of the tread during runflat operation.

U.S. Pat. No. 6,527,025 discloses a pneumatic tire comprised of a carcass ply extending between bead portions and including a topping rubber layer, the topping rubber layer facing the inside of the tire and made of a butyl rubber compound containing at least 10 parts by weight of butyl rubber or butyl rubber derivative; and a belt disposed radially outside the carcass in the tread portion, the belt comprising at least one ply of monofilament cords laid at an angle of from 10 to 40 degrees with respect to the circumferential direction of the tire, and each of the monofilament cord consisting of a single filament. The belt further comprises one ply of multifilament cords or one ply of monofilament cords. The height of a bead apex, which is disposed between a carcass ply turnup portion and main portion in each bead portion, can be reduced into a range of from 10 to 20 mm, and in this case, the carcass ply turnup portion is extended radially outwardly beyond the radially outer end of the bead apex so as to adjoin the carcass ply main portion.

U.S. Pat. No. 6,263,935 discloses a radial ply pneumatic tire having a carcass with a bead portion, a carcass reinforcing structure, and a bead filler. The carcass reinforcing structure has at least two structures with cords which extend to each bead. In a preferred embodiment of the invention, the tire carcass includes elastomeric first and second fillers, the first filler being located between the first ply structure and the innerliner of the tire, and the second filler being located between the first and second ply structures. The fillers stiffen the sidewalls to permit the tire to be driven while uninflated. The tire further includes an aramid overlay radially outwardly of the reinforcing belt.

### II. SUMMARY OF THE INVENTION

According to one embodiment of this invention, a tire carcass includes a first radial ply, a carcass crown portion, first and second sidewalls, the carcass crown portion having a first edge and a second edge, and a non-continuous second radial ply, the second radial ply having a right side extending from approximately the first edge of the carcass crown portion, and extending at least to the first bead core and a left side extending from approximately the second edge of the carcass crown portion, and extending at least to the second bead core, wherein at least one of the sidewalls and the carcass crown portion are made of dissimilar material.

According to another embodiment of this invention, the tire carcass further includes a non-continuous third radial ply, the third radial ply having a right side extending from approximately the first edge of the carcass crown portion, and extending at least to the first bead core and a left side extending from approximately the second edge of the carcass crown portion, and extending at least to the second bead core, the third radial ply overlaying the second radial ply.

According to another embodiment of this invention, the carcass has a center line parallel with the bead core.

According to another embodiment of this invention, the right side of the second radial ply is at an angle of at least approximately 75° with respect to the center line, and the left side of the second radial ply is at an angle of at least approximately −75° with respect to the center line.

According to another embodiment of this invention, the first radial ply is at a greater angle with respect to the center line than the angle of the right and left sides of the second radial ply.

According to another embodiment of this invention, the material for at least one of the sidewalls has an epi between about 24 and about 35 and the material in the crown portion has an epi between about 16 and 24.

According to another embodiment of this invention, right side of the second radial ply is at an angle of at least approximately 105° with respect to the center line, and the left side of the second radial ply is at an angle of at least approximately −105° with respect to the center line.

According to another embodiment of this invention, the right side of the second radial ply is at an angle of between at least approximately 75° and approximately 105° with respect to the center line, and the left side of the second radial ply is at an angle of between at least approximately −75° and approximately −105° with respect to the center line.

According to another embodiment of this invention, the right side of the second radial ply is at an angle of at least 90° with respect to the center line, and the left side of the second radial ply is at an angle of at least −90° with respect to the center line.

According to another embodiment of this invention, the right side of the second radial ply is at an angle of at least approximately 75° with respect to the center line, the left side of the second radial ply is at an angle of at least approximately −75° with respect to the center line, the right side of the third radial ply is at an angle of at least approximately 75° with respect to the center line, the left side of the third radial ply is at an angle of at least approximately −75° with respect to the center line.

According to another embodiment of this invention, the first radial ply is at a greater angle with respect to the center line than the angle of the left and right sides of the second and third plies.

According to another embodiment of this invention, the right side of the second radial ply is at an angle of at least approximately 105° with respect to the center line, the left side of the second radial ply is at an angle of at least approximately −105° with respect to the center line, the right side of the third radial ply is at an angle of at least approximately 105° with respect to the center line, and the left side of the third radial ply is at an angle of at least approximately −105° with respect to the center line.

According to another embodiment of this invention, the right side of the second radial ply is at an angle of between at least approximately 75° and approximately 105° with respect to the center line, the left side of the second radial ply is at an angle of between at least approximately −75° and approximately −105° with respect to the center line, the right side of the third radial ply is at an angle of between at least approximately −75° and approximately −105° with respect to the center line, and the left side of the third radial ply is at an angle of between at least approximately −75° and approximately −105° with respect to the center line.

According to another embodiment of this invention, the right side of the second radial ply is at an angle of at least 90° with respect to the center line, the left side of the second radial ply is at an angle of at least −90° with respect to the center line, the right side of the third radial ply is at an angle of at least 90° with respect to the center line, and the left side of the third radial ply is at an angle of at least −90° with respect to the center line.

According to another embodiment of this invention, the right and left sides of the second radial ply have a width that is approximately half of a width of the first radial ply.

According to another embodiment of this invention, the right and left sides of the second and third radial plies have a width that is approximately half of a width of the first radial ply.

According to another embodiment of this invention, a pneumatic tire includes a carcass, includes a first radial ply, a carcass crown portion, first and second sidewalls, the carcass crown portion having a first edge and a second edge, and a non-continuous second radial ply, the second radial ply having a right side extending from approximately the first edge of the carcass crown portion, and extending at least to the first bead core and a left side extending from approximately the second edge of the carcass crown portion, and extending at least to the second bead core, wherein at least one of the sidewalls and the carcass crown portion are made of dissimilar material.

According to another embodiment of this invention, a tire carcass includes a first radial ply, a carcass crown portion, the carcass crown portion having a first edge and a second edge, and at least a second non-continuous radial ply, the second radial ply having a right side extending approximately to at least the first bead core and a left side extending approximately to at least the second bead core, wherein at least one of the sidewalls and the carcass crown portion are made of dissimilar material.

According to another embodiment of the invention, the material in the crown portion has a lower material strength than at least one of the sidewalls, wherein the material strength is determined by at least one of the following group comprising: Shore A hardness, compounding, cord diameter, tensile strength, and twists per inch.

According to another embodiment of the invention, the material in the crown portion has a lower, the same, or higher material strength than at least one of the sidewalls, wherein the material strength is determined by at least one of the following group comprising: Shore A hardness, compounding, cord diameter, tensile strength, and twists per inch.

One advantage of this invention is by utilizing a lesser strength material in the crown of the tire, the cost of the tire can be substantially reduced without compromising performance.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a cross-section of the ply section of a tire showing a mono-ply construction;

FIG. 2 is a cross-section of the ply-section of a tire, showing belts and the mono-ply construction;

FIG. 3 is a cross-section of the ply-section of a tire, showing the third radial ply;

FIG. 4 is a top view of the carcass, showing angles of the plies;

FIG. 5 is a top view of the carcass, showing angles of the plies;

FIG. 6 is a top view of the carcass, showing angles of the plies;

FIG. 7 is a top view of the carcass, showing angles of the plies;

FIG. 8 is a top view of the carcass, showing angles of the plies;

FIG. 9 is a top view of the carcass, showing angles of the plies; and,

FIG. 10 is a perspective view of a prior art tire.

### IV. DEFINITIONS

The following terms may be used throughout the descriptions presented herein and should generally be given the following meaning unless contradicted or elaborated upon by other descriptions set forth herein.

“Axial” and “axially” mean the lines or directions that are parallel to the axis of rotation of the tire.

“Carcass” means the tire structure apart from the belt structure, tread, undertread, and sidewall rubber over the plies, but including bead cores.

“Carcass crown portion” means the portion of the carcass over which the crown is placed.

“Crown” or “tire crown” means the tread, tread shoulders, and the immediately adjacent portions of the sidewalls.

“Interior” means, generally, the inside surface of the tire.

“Exterior” means, generally, the outside surface of the tire.

“Pneumatic tire” means a laminated mechanical device of generally toroidal shape (usually an open-torus) having bead cores and a tread and made of rubber, chemicals, fabric and steel or other materials. When mounted on the wheel of a motor vehicle, the tire through its tread provides traction and contains the fluid that sustains the vehicle load.

“Radial” and “radially” mean directions toward or away from the axis of rotation of the tire.

“Sidewall” means that component which comprises a portion of the outside surface of a tire between the tread and the bead.

### V. DETAILED DESCRIPTION OF THE INVENTION

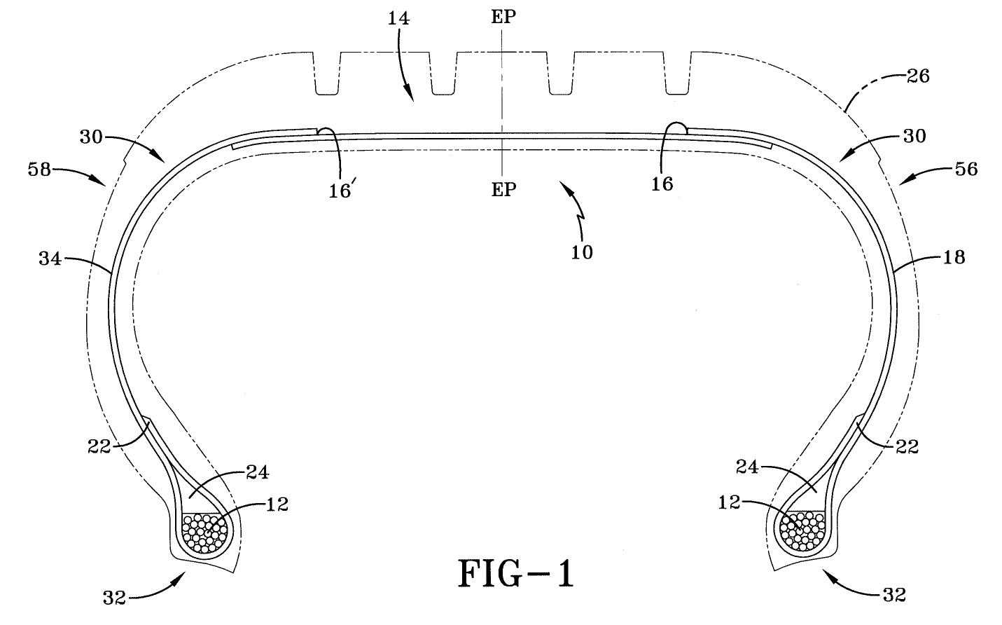

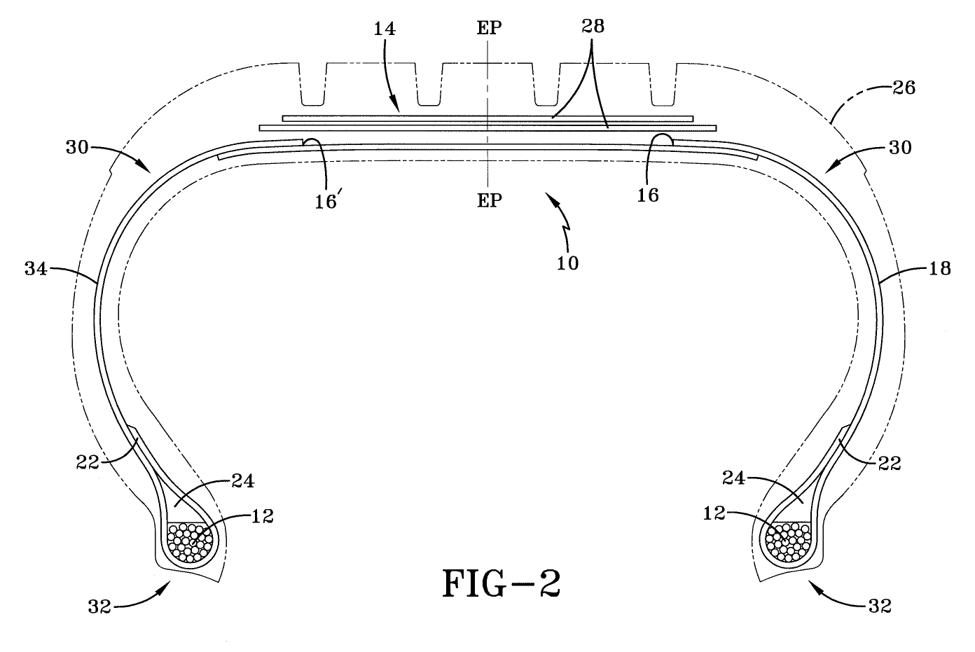

Referring now to the drawings wherein the showings are for purposes of illustrating embodiments of the invention only and not for purposes of limiting the same, FIG. 1 shows a tire carcass 10, having two beads 12, sidewalls 56, 58, a carcass crown portion 14 (wherein the carcass crown portion 14 has two edges 16, 16′), a first radial ply 20, a second radial ply having a right side 18 and a left side 34, turn-up ends 22, apexes 24, shoulders 30, and bead regions 32. The bead regions 32 have a pair of axially spaced beads 12 around which are wrapped turn-up ends 22. The apexes 24 are sandwiched between the main body of the carcass 10 and the turn-up ends 22. The carcass 10 is surrounded by tread 26. In FIGS. 2-4, the carcass 10 is shown with belts 28 overlaying the carcass crown portion 14. In one embodiment, at least one of the sidewalls 56, 58 and the crown portion 14 are made of dissimilar materials. In one embodiment, the crown portion 14 is made of a material with lesser strength than the sidewalls 56, 58. It is contemplated within this invention that the sidewalls 56, 58 could be made of a similar material, and the crown portion 14 of a dissimilar material, sidewall 56 being made of a dissimilar material from sidewall 58 and crown portion 14, sidewall 58 being made of a dissimilar material from sidewall 56 and crown portion 14, or sidewall 56, sidewall 58, and crown portion 14 all being made of dissimilar materials. It is also contemplated within this invention that each could have a material with similar, lesser, or higher strength, with material strength being determined by Shore A hardness, compounding, cord diameter, tensile strength, and/or twists per inch.

With continuing reference to FIGS. 1 and 2, the first radial ply 20 is a continuous ply that extends to the beginning of the shoulders 30. The carcass crown portion 14 is defined by the edges 16, 16′, and the right side 18 of second radial ply and the left side 34 of the second radial ply begin at the edges 16, 16′, and extend around the beads 12 and end in turn-up ends 22. The right and left sides 18, 34 of the second radial ply overlay the first radial ply 20, such that the sidewall region of the carcass 10 is two-ply in this embodiment.

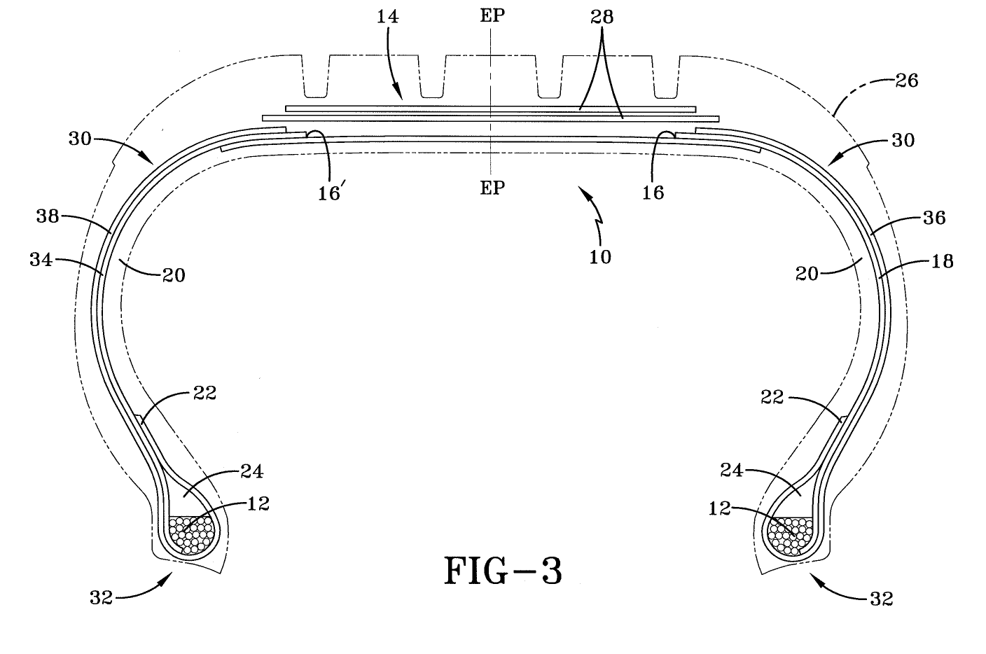

With reference now to FIG. 3, another embodiment of the invention is shown, wherein the carcass 10 has a third radial ply having a right side 36, which begins at the first edge 16 of the crown carcass portion 14, overlays the right side 18 of the second radial ply, and extends around the bead 12 and end in turn-up end 22. The left side 38 of the third radial ply, which begins at the second edge 16′ of the crown carcass portion 14, overlays the left side 34 of the second radial ply, and extends around the bead 12 and end in turn-up end 22. As can be seen in FIG. 3, in one embodiment, the sides 36, 38 of the third ply overlay the second radial ply in a staggered fashion. The third radial ply is slightly shorter than the second radial ply. The plies are also staggered at the turn-up ends 22 as well.

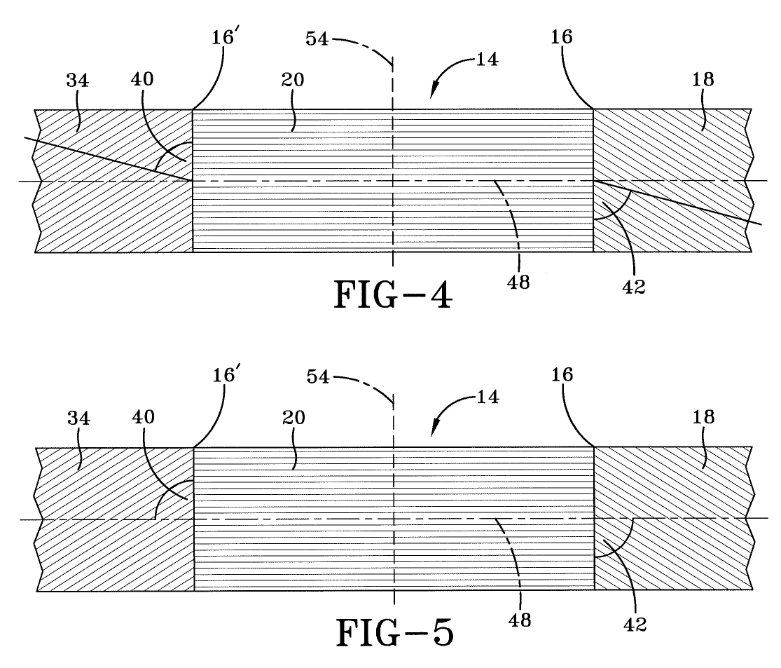

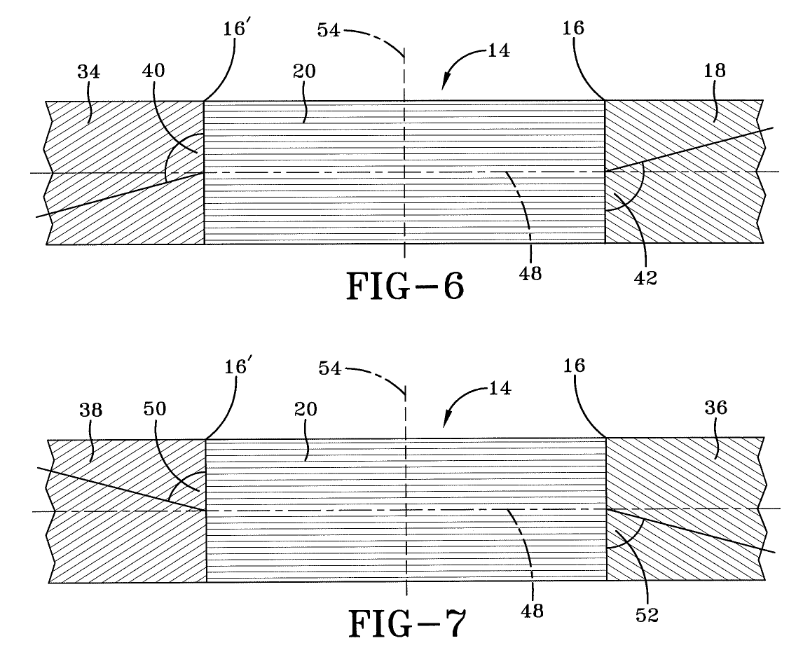

With reference now to FIGS. 4-6, the FIGURES show the tire carcass 10 from the top, showing the angles of the plies. The sides 18, 34 can be at a variety of angles. The rights side 18 has a first edge 44 and the left side 34 has a first edge 46. A centerline 48 is shown in the FIGURES, and the angles 40, 42 are shown with respect to the centerline 48. In one embodiment, the angles 40, 42 are −75° and 75°, respectively, with respect to the centerline 48. The angles 40, 42 represent the angle of the sides 18, 34. In another embodiment, the angles 40, 42 are both 90°, and in another embodiment, the angles 40, 42 are −105° and 105°, respectively, with respect to the centerline 48. It is to be understood that in this embodiment, angle 40 can be any angle between approximately −75° and approximately −105° and angle 42 can be any angle between approximately 75° and approximately 105°. It is also to be understood that the invention is not intended to be limited by the angles 40, 42, and that any angle can be chosen, as long as chosen using sound engineering judgment. The FIGURES also show a parallel centerline 54.

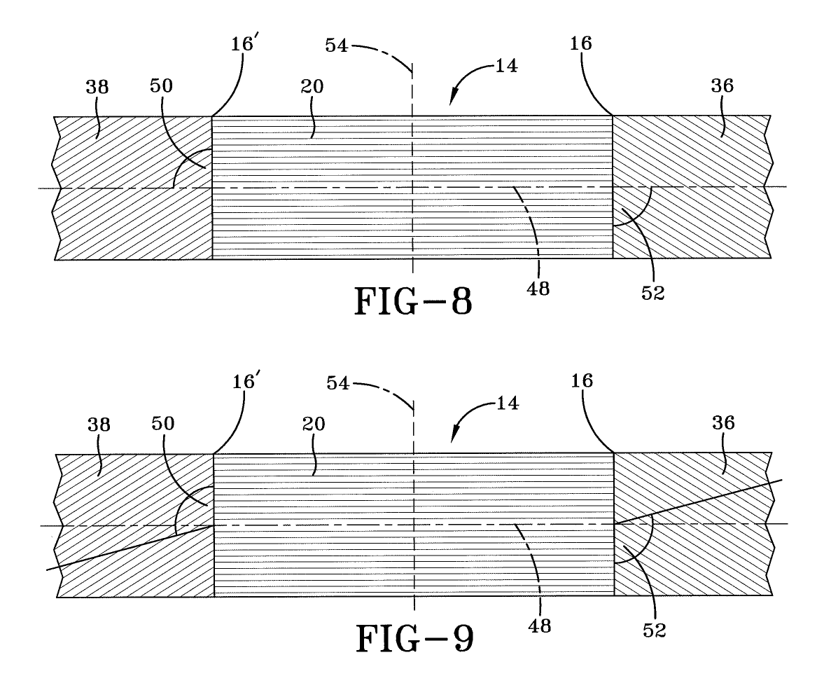

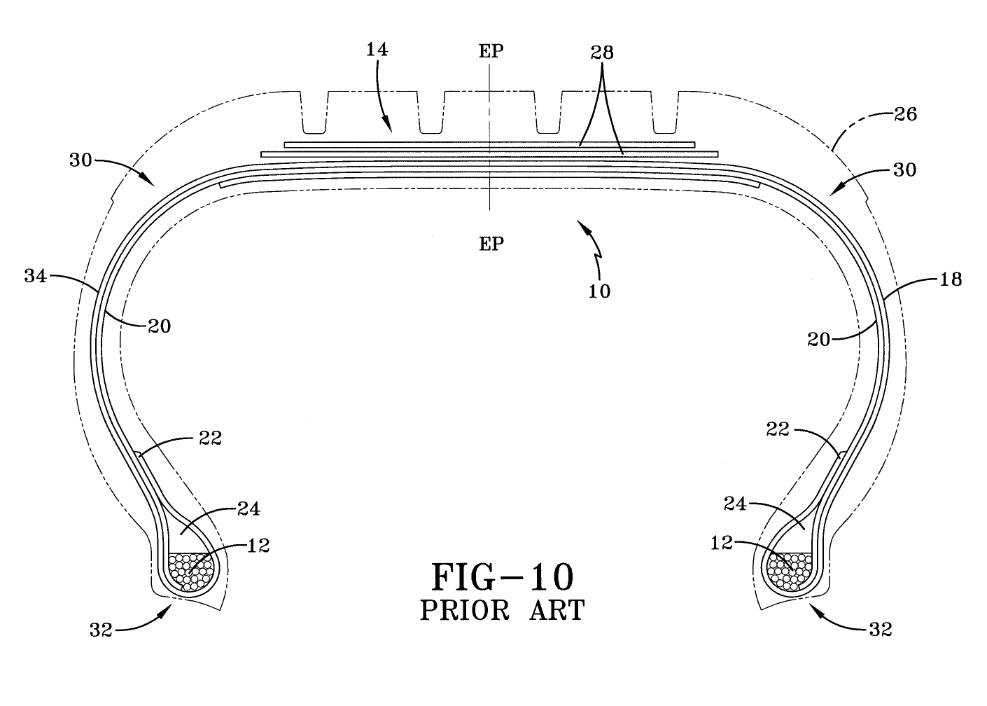

With reference now to FIGS. 7-9, the sides 36, 38 can be at a variety of angles. The right side 36 has a first edge 44′ and the left side 38 has a first edge 46′. A centerline 48 is shown in the FIGURES, and the angles 50, 52 are shown with respect to the centerline 48. In one embodiment, the angles 50, 52 are −75° and 75°, respectively, with respect to the centerline 48. The angles 50, 52 represent the angle of the sides 36, 38. In another embodiment, the angles 50, 52 are both 90°, and in another embodiment, the angles 50, 52 are −105° and 105°, respectively, with respect to the centerline 48. It is to be understood that in this embodiment, angle 50 can be any angle between approximately −75° and approximately −105° and angle 52 can be any angle between approximately 75° and approximately 105°. It is also to be understood that the invention is not intended to be limited by the angles 50, 52, and that any angle can be chosen, as long as chosen using sound engineering judgment.

With continuing reference to FIGS. 7-9, in this embodiment, the sides 36, 38 overlay the sides 18, 34. In this embodiment, it is to be understood that angle 40 can be any angle between approximately −75° and approximately −105° and angle 42 can be any angle between approximately 75° and approximately 105°. It is also to be understood that the invention is not intended to be limited by the angles 40, 42, and that any angle can be chosen, as long as chosen using sound engineering judgment. It is also to be understood that the angles 40, 42 can either be the same as the angles 50, 52 or they can be different.

With reference now to FIGS. 1-9, the plies can be made of either similar or dissimilar materials, but the type of material is not intended to be a limitation to this invention, and it is to be understood that the plies could be made of any material chosen using sound engineering judgment.

With continuing reference to FIGS. 1-9, it is to be understood that the plies can be of any length, including extending to the turn-up ends 22, as long as the sides 18, 34 do not connect to each other and sides 36, 38 do not connect to each other. It is also to be understood that the invention is not limited to three plies, but any number of plies could be used, as long as chosen using sound engineering judgment. It is also to be understood that the tire could have two or more continuous plies and two or more non-continuous plies. It is also to be understood that the sides 18, 34 of the second ply and the sides 36, 38 of the third ply, in one embodiment, do not wrap around the bead core 12, but extend to the bead core 12. The sides 18, 34, 36, 38 can extend to the bead core 12, partially around the bead core 12, or all the way around the bead core 12. It is also to be understood that the sides 18, 34, 36, 38 can extend beyond the edges 16, 16′ of the carcass crown portion 14. Although in one embodiment, the sides 18, 34, 36, 38 begin at approximately the edge 16, 16′, it is to be understood that this invention encompasses the sides 18, 34, 36, 38 extending substantially beyond the edges 16, 16′ as long as the second and third plies do not become a continuous ply.

Several embodiments of the invention were tested for the crown portion 14 and the sidewalls 56, 58, wherein the material in the crown portion 14 has an epi (ends per inch) of between about 16 and about 24 and the material in the sidewalls 56, 58 has an epi of between about 24 and 35. In one embodiment, the sidewalls 56, 58 were 1000/2 (1000 decitex linear density/2 yarns per ply) polyester with 35 epi. Several embodiments of the crown portion 14 included 1000/2 polyester with 24 epi, 840/2 nylon with 16 epi, and 840/2 nylon with 21 epi. The lesser strength material in the crown portion 14 did not compromise the performance of the tire.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A tire carcass comprising:
a first radial ply;
a first sidewall;
a second sidewall;
a carcass crown portion, the carcass crown portion having a first edge and a second edge; and,
a non-continuous second radial ply, the second radial ply having a right side extending from approximately the first edge of the carcass crown portion, and extending at least to the first bead core and a left side extending from approximately the second edge of the carcass crown portion, and extending at least to the second bead core, wherein at least one of the sidewalls and the carcass crown portion are made of dissimilar material.

2. The tire carcass of claim 1, wherein the tire carcass further comprises:
a non-continuous third radial ply, the third radial ply having a right side extending from approximately the first edge of the carcass crown portion, and extending at least to the first bead core, and a left side extending from approximately the second edge of the carcass crown portion, and extending at least to the second bead core, the third radial ply overlaying the second radial ply.

3. The tire carcass of claim 1, wherein the material in the crown portion has a lower material strength than at least one of the sidewalls, wherein the material strength is determined by at least one of the following group comprising: Shore A hardness, compounding, cord diameter, tensile strength, and twists per inch.

4. The tire carcass of claim 3, wherein the carcass has a center line perpendicular to the bead core, wherein the right side of the second radial ply is at an angle of at least approximately 75° with respect to the center line, and the left side of the second radial ply is at an angle of at least approximately −75° with respect to the center line.

5. The tire carcass of claim 4, wherein the right side of the second radial ply is at an angle of at least approximately 105° with respect to the center line, and the left side of the second radial ply is at an angle of at least approximately −105° with respect to the center line.

6. The tire carcass of claim 4, wherein the right side of the second radial ply is at an angle of between at least approximately 75° and approximately 105° with respect to the center line, and the left side of the second radial ply is at an angle of between at least approximately −75° and approximately −105° with respect to the center line.

7. The tire carcass of claim 2, wherein the material in the crown portion has a lower material strength than at least one of the sidewalls, wherein the material strength is determined by at least one of the following group comprising: Shore A hardness, compounding, cord diameter, tensile strength, and twists per inch.

8. The tire carcass of claim 7, wherein the material for at least one of the sidewalls has an epi between about 24 and about 35 and the material in the crown portion has an epi between about 16 and 24.

9. The tire carcass of claim 7, wherein the first radial ply is at a greater angle with respect to the center line than the angle of the left and right sides of the second and third plies.

10. The tire carcass of claim 7, wherein the right side of the second radial ply is at an angle of at least approximately 105° with respect to the center line, the left side of the second radial ply is at an angle of at least approximately −105° with respect to the center line, the right side of the third radial ply is at an angle of at least approximately 105° with respect to the center line, and the left side of the third radial ply is at an angle of at least approximately −105° with respect to the center line.

11. The tire carcass of claim 7, wherein the right side of the second radial ply is at an angle of between at least approximately 75° and approximately 105° with respect to the center line, the left side of the second radial ply is at an angle of between at least approximately −75° and approximately −105° with respect to the center line, the right side of the third radial ply is at an angle of between at least approximately −75° and approximately −105° with respect to the center line, and the left side of the third radial ply is at an angle of between at least approximately −75° and approximately −105° with respect to the center line.

12. The tire carcass of claim 1, wherein the material in the crown portion has the same or higher material strength than at least one of the sidewalls, wherein the material strength is determined by at least one of the following group comprising: Shore A hardness, compounding, cord diameter, tensile strength, and twists per inch.

13. The tire carcass of claim 2, wherein the material in the crown portion has the same or higher material strength than at least one of the sidewalls, wherein the material strength is determined by at least one of the following group comprising: Shore A hardness, compounding, cord diameter, tensile strength, and twists per inch.

14. The tire carcass of claim 1, wherein the right and left sides of the second radial ply have a combined width that is approximately half of a width of the first radial ply.

15. The tire carcass of claim 2, wherein the right and left sides of the second and third radial plies have a combined width that is approximately half of a width of the first radial ply.

16. The tire carcass of claim 3, wherein the material for at least one of the sidewalls has an epi between about 24 and about 35 and the material in the crown portion has an epi between about 16 and 24.

17. A tire carcass comprising:
a first radial ply;
sidewalls;
a carcass crown portion, the carcass crown portion having a first edge and a second edge; and,
at least a second non-continuous radial ply, the second radial ply having a right side extending approximately to at least the first bead core and a left side extending approximately to at least the second bead core, wherein at least one of the sidewalls and the carcass crown portion are made of dissimilar material.

18. The tire carcass of claim 17, wherein the material in the crown portion has a lower, the same, or higher material strength than at least one of the sidewalls, wherein the material strength is determined by at least one of the following group comprising: Shore A hardness, compounding, cord diameter, tensile strength, and twists per inch.

19. The tire carcass of claim 17, wherein the first sidewall, the second sidewall, and the crown portion are all made of dissimilar materials.

20. A pneumatic tire comprising:
a carcass;
a first radial ply with shoulder portions and lateral edge portions, each of the lateral edge portions being wrapped around a bead core;
a first sidewall;
a second sidewall;
a carcass crown portion, the carcass crown portion having a first edge and a second edge; and,
at least a second radial ply, wherein the second radial ply is non-continuous, the second radial ply having a right side extending from approximately the first edge of the carcass crown portion, and extending approximately to the first bead core and a left side extending from approximately the second edge of the carcass crown portion, and extending approximately to the second bead core, wherein at least one of the sidewalls and the carcass crown portion are made of dissimilar material.
